(19) United States
(12) Patent Application Publication
(10) Pub. No.: US 2014/0092416 A1
(43) Pub. Date: Apr. 3, 2014

(54) DETECTING DEVICE, PROCESSING DEVICE, IMAGE FORMING APPARATUS AND NON-TRANSITORY COMPUTER READABLE MEDIUM

(71) Applicant: FUJI XEROX CO., LTD., Tokyo (JP)

(72) Inventor: Kenta OGATA, Kanagawa (JP)

(73) Assignee: FUJI XEROX CO., LTD., Tokyo (JP)

(21) Appl. No.: 13/747,002

(22) Filed: Jan. 22, 2013

(30) Foreign Application Priority Data
Sep. 28, 2012 (JP) 2012-216805

(51) Int. Cl. G06K 15/00

(52) U.S. Cl. CPC G06K 15/406
USPC 358/1.14

(57) ABSTRACT

Provided is a detecting device including an emission unit that emits first detection waves in order to detect presence of an object, a first receiving unit that receives reflective waves of which the first detection waves reach the object and are reflected thereon, and outputs a signal representing a value corresponding to a distance from the object based on the reflective waves, a determination unit that determines a threshold corresponding to a predetermined second distance based on a value of a first signal output by the first receiving unit when the first detection waves reach a reference plate and are reflected thereon, and a first detecting unit that compares a value of a second signal output by the first receiving unit with the threshold, and detects whether or not the object is within a first range where the distance to the first receiving unit is shorter than the second distance.

### CROSS-REFERENCE TO RELATED APPLICATIONS

This application is based on and claims priority under 35 USC 119 from Japanese Patent Application No. 2012-216805 filed Sep. 28, 2012.

### BACKGROUND

### Technical Field

The present invention relates to a detecting device, a processing device, an image forming apparatus and a non-transitory computer readable medium.

### SUMMARY

According to an aspect of the invention, there is provided a detecting device including: an emission unit that emits first detection waves in order to detect presence of an object; a first receiving unit that receives reflective waves of which the first detection waves emitted by the emission unit reach the object and are reflected thereon, and outputs a signal representing a value corresponding to a distance from the object based on the reflective waves; a determination unit that determines a threshold corresponding to a predetermined second distance based on a value of a first signal output by the first receiving unit when the first detection waves reach a reference plate and are reflected thereon, in a case where the reference plate is disposed on a path of the first detection waves emitted by the emission unit and at a position where a distance to the first receiving unit is a predetermined first distance; and a first detecting unit that compares a value of a second signal output by the first receiving unit when the first detection waves emitted by the emission unit reach the object other than the reference plate and are reflected thereon, with the threshold determined by the determination unit, and detects whether or not the object is within a first range where the distance to the first receiving unit is shorter than the second distance.

### BRIEF DESCRIPTION OF THE DRAWINGS

Exemplary embodiments of the present invention will be described in detail based on the following figures, wherein:

FIG. 1 is a view showing an appearance of an image forming apparatus according to a first exemplary embodiment of the invention;

FIG. 2 is a block diagram showing an overall configuration of the image forming apparatus according to the first exemplary embodiment of the invention;

FIG. 3 is a view showing a mechanism to detect an object by a sensor according to the first exemplary embodiment of the invention;

FIG. 4 is a diagram showing a functional configuration of a controller of the image forming apparatus according to the first exemplary embodiment of the invention;

FIG. 5 is a graph illustrating a characteristic variation of a receiving unit of the image forming apparatus according to the first exemplary embodiment of the invention;

FIG. 6 is a flowchart showing an operation flow of the image forming apparatus according to the first exemplary embodiment of the invention;

FIG. 7 is a block diagram showing an overall configuration of an image forming apparatus according to a second exemplary embodiment of the invention;

FIGS. 8A to 8C are views showing a configuration of a second receiving unit according to the second exemplary embodiment of the invention;

FIG. 9 is a diagram showing a functional configuration of a controller of the image forming apparatus according to the second exemplary embodiment of the invention; and

FIGS. 10A and 10B are flowcharts showing an operation flow of the image forming apparatus according to the second exemplary embodiment of the invention.

### DETAILED DESCRIPTION

### 1. First Exemplary Embodiment

### 1-1. Overall Configuration of Image Forming Apparatus

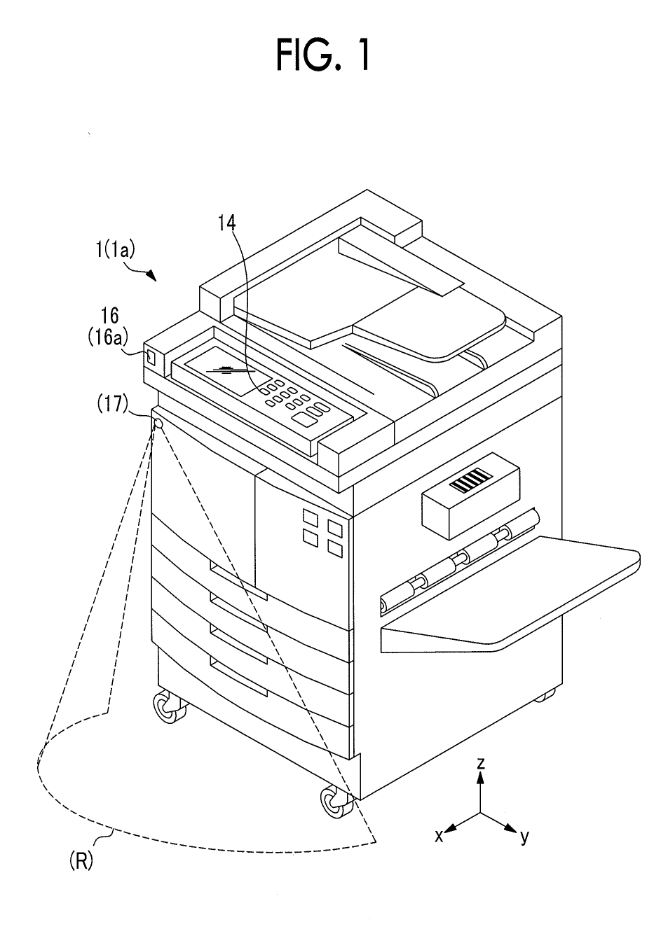

FIG. 1 is a view showing an appearance of an image forming apparatus 1 according to a first exemplary embodiment of the invention. Hereinafter, in the drawings, a space for each configuration being disposed is represented as an xyz right-handed system coordinate space in order to describe the arrangement of each configuration of the image forming apparatus 1. Among the coordinate symbols shown in the drawings, a symbol in which a black circle is depicted in a white circle represents an arrow directed from the depth side to the front side in the depth direction of paper. A symbol in which two crossed lines are depicted in a white circle represents an arrow directed from the front side to the depth side in the depth direction of the paper. The direction along an x axis in the space indicates an x axial direction. In the x axial direction, the direction in which x components increase indicates a positive x-direction and the direction in which x components decrease indicates a negative x-direction. In a similar way to x components, a positive y-direction and a negative y-direction in a y axial direction and a positive z-direction and a negative z-direction in a z axial direction are defined with respect to y components and z components.

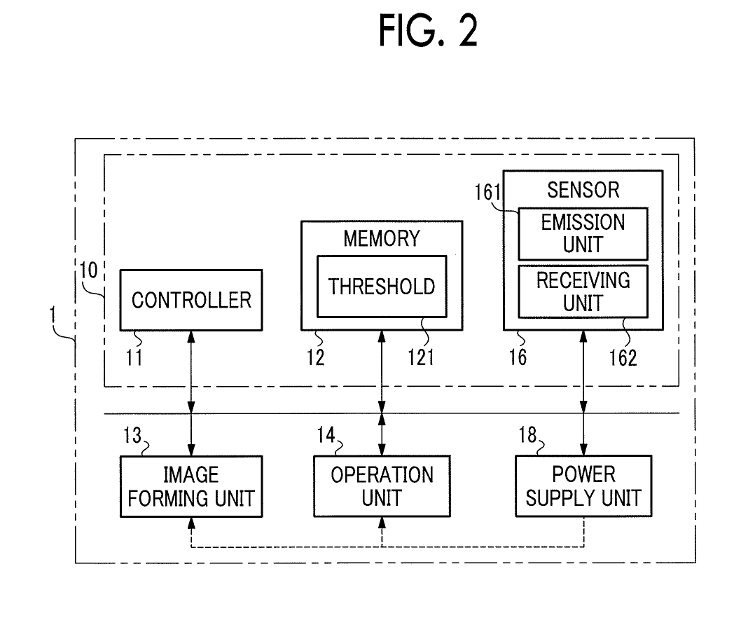

FIG. 2 is a block diagram showing an overall configuration of the image forming apparatus 1 according to the first exemplary embodiment. As shown in FIG. 2, the image forming apparatus 1 includes a controller 11, a memory 12, an image forming unit 13, an operation unit 14, a sensor 16 and a power supply unit 18. As shown in FIG. 2, the controller 11, the memory 12 and sensor 16 function as a detecting device 10 that detects whether or not an object, such as the human body of a user, is in a range of which a distance to a receiving unit 162 of the sensor 16 is less than a predetermined distance.

The controller 11 includes a CPU (Central Processing Unit), a ROM (Read Only Memory) and a RAM (Random Access Memory). The CPU reads and executes a computer program (hereinafter, simply referred to as program) stored in the ROM and the memory 12, thereby controlling each unit of the image forming apparatus 1.

The operation unit 14 includes an operator, such as an operation button, for various instructions. When an operation by a user is received, the operation unit 14 supplies a signal that corresponds to the operation content to the controller 11. Moreover, the operation unit 14 may include a display screen for displaying a change in the state or the like of the image forming apparatus 1 in accordance with the received operation.

The memory 12 is a large-capacity memory such as a hard disk drive, and stores a program to be read by the CPU of the controller 11. Moreover, the memory 12 stores a threshold 121 to compare with a value of a signal output by the receiving unit 162 of the sensor 16, in addition to various data, such as image data representing an image to be formed on a medium.

The image forming unit 13 forms an image that is represented by image data designated by the controller 11, on a medium such as paper, using an electrophotographic system. The medium may not be limited to only paper but the medium may be a resin sheet. That is to say, any medium may be used as long as it is possible to record the image on a surface of the medium. The image data may be image data that the controller 11 obtains from an external device through a communication unit (not shown). The external device includes, for example, a reading device that reads an original image or a storage device that stores data representing the image.

As shown in FIG. 1, the sensor 16 is provided on a plate in the front side of a housing of the image forming apparatus 1. The front side means a side facing a user's body when the user operates the operation unit 14 and a side directed toward the positive x-direction when seen from the housing, as in FIG. 1. The sensor 16 includes an emission unit 161 and the receiving unit 162.

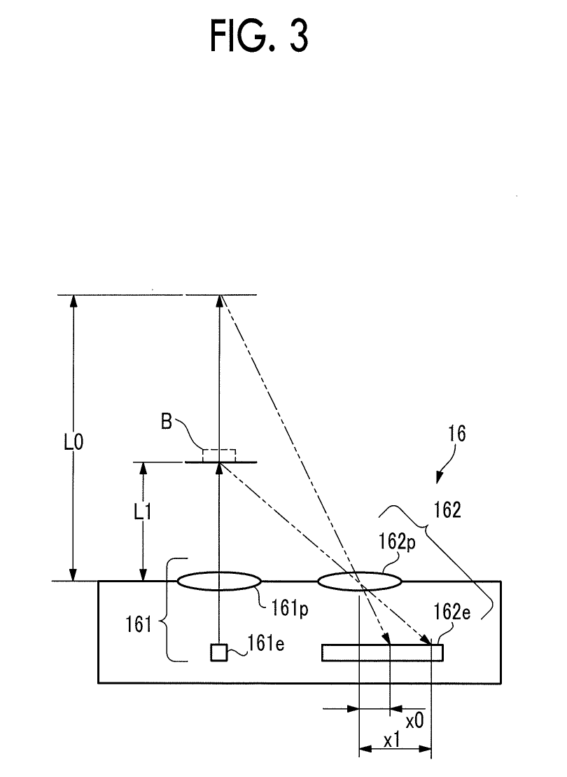

FIG. 3 is a view showing a mechanism to detect an object by the sensor 16 according to the first exemplary embodiment. The emission unit 161 emits detection waves for detecting a presence of the object. The emission unit 161 shown in FIG. 3 includes an LED (Light Emitting Diode) 161e that emits infrared rays, and lens 161p that focuses the emitted infrared rays towards the object. In this case, the infrared rays are the detection waves. Moreover, the detection waves may not be limited to the infrared rays but may be visible rays or ultrasonic waves. That is, the detection waves may be any wave as long as it is possible to know a value corresponding to a distance from an object based on reflective waves reflected by the object.

The receiving unit 162 receives the reflective waves of which the detection waves emitted by the emission unit 161 reach the object and are reflected. The receiving unit 162 outputs a signal that represents the value corresponding to the distance from the object based on the reflective waves. The receiving unit 162 includes, for example, a position sensitive detector (PSD) 162e and a lens 162p that focuses the reflective waves reflected from the object towards the position sensitive detector 162e.

When the infrared rays (detection waves) emitted from the LED 161e of the emission unit 161 through the lens 161p reach the object at a distance L1 position from the lens 161p, as shown in FIG. 3, the infrared rays are reflected on the object. The infrared rays (detection waves) reflected from the object reach the position sensitive detector 162e through the lens 162p of the receiving unit 162 and are received at a position separated from a reference position in the position sensitive detector 162e by the distance×1. On the other hand, when the infrared rays reach the object positioned at a distance L0 position where a distance from the lens 161p is farther than the above-described distance L1, the infrared rays reflected from the object are received at a position separated from the reference position in the position sensitive detector 162e by the distance×0.

When the distance L1<the distance L0, the relationship of the distance×1>the distance×0 is satisfied. A ratio of the distance×1 to the distance×0 and a ratio of the distance L1 to the distance L0 are correlative. Therefore, if the Distance×1 between a light receiving position of the reflective waves when the object is positioned at the predetermined distance L1 and the reference position is clearly known, it is possible to obtain the distance L0 corresponding to a case where the distance×0 between the light receiving position of the reflective waves that are reflected from the object positioned at an unknown distance L0 and the reference position is obtained. The receiving unit 162 obtains a value corresponding to a position where the position sensitive detector 162e receives the reflective waves, for example, using a ratio of voltage generated in both ends thereof and outputs a signal representing the value. According to this, the signal is a signal representing the value corresponding to the distance from the object that has reflected the detection waves.

When the position sensitive detector 162e receives the reflective waves, the receiving unit 162 outputs the signal representing the value corresponding to the distance from the object, from the reception position. However, a configuration in which the signal is output from the received reflective waves is not limited to this configuration. For example, the receiving unit 162 may specify the distance from the object in accordance with the decay rate of the received reflective waves so as to output the above-described signal. Alternatively, in a case where the detection waves are sound waves or the like, the receiving unit 162 may specify the distance from the object in accordance with the time between when the emission unit 161 emits the sound waves and when the receiving unit 162 receives the sound waves so as to output the above-described signal.

When the detecting device 10 detects the presence of the user as the object within a predetermined range, the power supply unit 18 supplies electric power to the operation unit 14 so as to start receiving an operation from the user and supplies the electric power to the image forming unit 13 so as to form an image.

The image forming apparatus 1 includes a reference plate B disposed on the path of the infrared rays emitted by the emission unit 161 and at the position where the distance to the receiving unit 162 is a predetermined first distance. The first distance is, for example, the above-described distance L1. Therefore, as shown in FIG. 3, when the calibration of the sensor 16 is performed, the reference plate B is disposed at the position where the distance to the receiving unit 162 is the distance L1, by the user and when the actual detection is performed, the reference plate B is removed by the user. The position where the distance to the receiving unit 162 is the distance L1 is, for example, the surface of the housing of the image forming apparatus 1. A plate through which the infrared rays pass is provided on the surface thereof and the receiving unit 162 is provided at the position heading toward the inside from the plate by the distance L1. The user attaches the reference plate B, such as a gray sheet, on the plate, thereby performing the calibration operation of the receiving unit 162.

### 1-2. Functional Configuration of Image Forming Apparatus

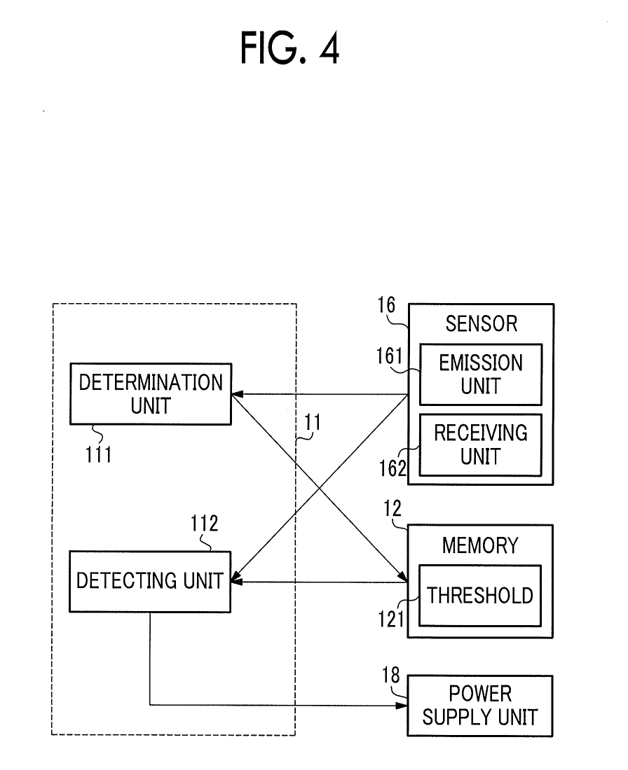

FIG. 4 is a diagram showing a functional configuration of the controller 11 of the image forming apparatus 1 according to the first exemplary embodiment. As shown in FIG. 4, the controller 11 functions as a determination unit 111 and a detecting unit 112.

For example, in order for the calibration of the receiving unit 162, when the electric power is supplied to the operation unit 14, the user performs the calibration operation using the operation unit 14. The user disposes the reference plate B at the position where the distance to the receiving unit 162 is the distance L1 (first distance), like the surface of the above-described plate. In the calibration operation, when the infrared rays emitted by the emission unit 161 reach the reference plate B and are reflected thereon, the determination unit 111 determines the threshold 121 corresponding to a predetermined second distance, based on a value of a first signal output by the receiving unit 162 that receives the reflective waves. The controller 11 stores the threshold 121 determined by the determination unit 111 in the memory 12. The predetermined second distance is stored in a predetermined region of the memory 12.

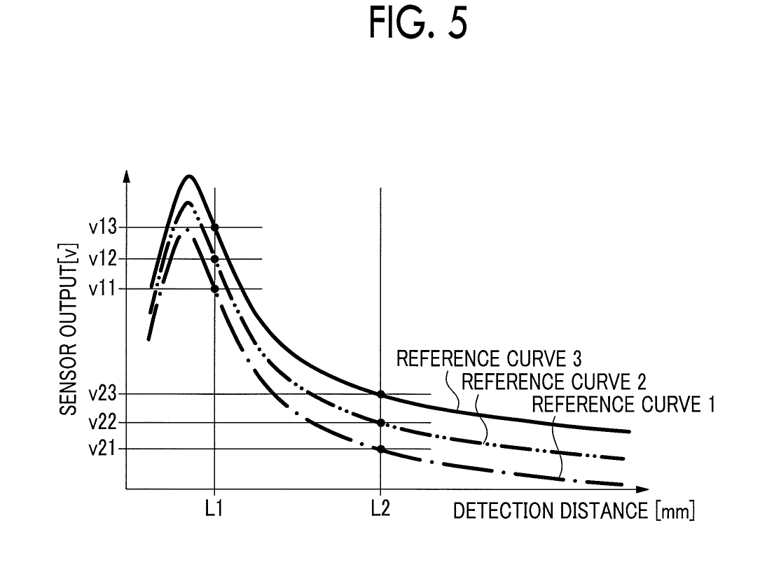

FIG. 5 is a graph illustrating a characteristic variation of the receiving unit 162 according to the first exemplary embodiment. The vertical axis in FIG. 5 represents a sensor output [v] that is an example of the signal representing the value corresponding to the direction from the object which reflects the detection waves. The horizontal axis in FIG. 5 represents a detection distance [mm] that is the distance from the object which reflects the infrared rays emitted by the emission unit 161 to the receiving unit 162. The distance L1 is the distance from the position at which the reference plate B is disposed to the receiving unit 162, and the distance L1 is determined in advance. The distance L2 is the second distance stored in the predetermined region of the memory 12. The distance L2 (second distance) represents a radius of a region centering on the receiving unit 162. When the presence of the user is detected within the region, the power supply unit 18 supplies the electric power to the image forming unit 13.

The receiving unit 162 includes the position sensitive detector 162e. However, since there is variation in a position where the position sensitive detector 162e is fixed, a relationship between the output of the receiving unit 162 and the distance to an actual object may be different depending on each production lot. Three reference curves are shown in FIG. 5 in such a manner that the sampling is performed on the produced plural receiving units 162 and a relationship between the distance to the object, which emits the reflective waves, and the output of the receiving unit 162 when the reflective waves are received is divided into three systems. That is, since there is variation in the characteristics of the receiving unit 162 depending on the relationship between the distance and the output, any one of the three reference curves may be applied.

When the user disposes the reference plate B at the distance L1 position and performs the calibration operation through the operation unit 14, the receiving unit 162 receives the reflective waves from the disposed reference plate B and then outputs a signal corresponding to the reflective waves, for example, v1 [V]. At this time, the determination unit 111 compares the acquired v1 with the output values v11, v12 and v13 that may be output by the receiving unit 162 when the respective reference curves 1 to 3 receive the reflective waves emitted from the distance L1, and determines a threshold corresponding to the closest value. For example, when it is determined that v1 is the closest to v11 among the three output values, the determination unit 111 determines that the receiving unit 162 to be calibrated has the characteristics of the reference curve 1 as shown in FIG. 5. Therefore, the determination unit 111 determines v21 [V], for example, as the threshold 121 corresponding to the distance L2 (second distance), among v21, v22 and v23. The determined value is stored in the predetermined memory region of the memory 12, by the controller 11.

The detecting unit 112 detects whether or not a user, as the object, is within the range where the distance to the receiving unit 162 is shorter than the distance L2, using the calibrated receiving unit 162 by the above-described calibration operation. That is, the detecting unit 112 compares a value of a second signal, which is output by the receiving unit 162 when the infrared rays (detection waves) emitted by the emission unit 161 reach the user as the object other than the reference plate B and are reflected thereon, with the threshold determined by the determination unit 111. Thereafter, the detecting unit 112 detects whether or not the user is within the range where the distance to the receiving unit 162 is shorter than the distance L2, depending on the comparison result.

When the detecting unit 112 detects that the user is within the above-described range, the power supply unit 18 supplies the electric power to the operation unit 14 and then the reception of the operation from the user is started. Moreover, the power supply unit 18 supplies the electric power to the image forming unit 13 and then an image is formed.

### 1-3. Operation of Image Forming Apparatus

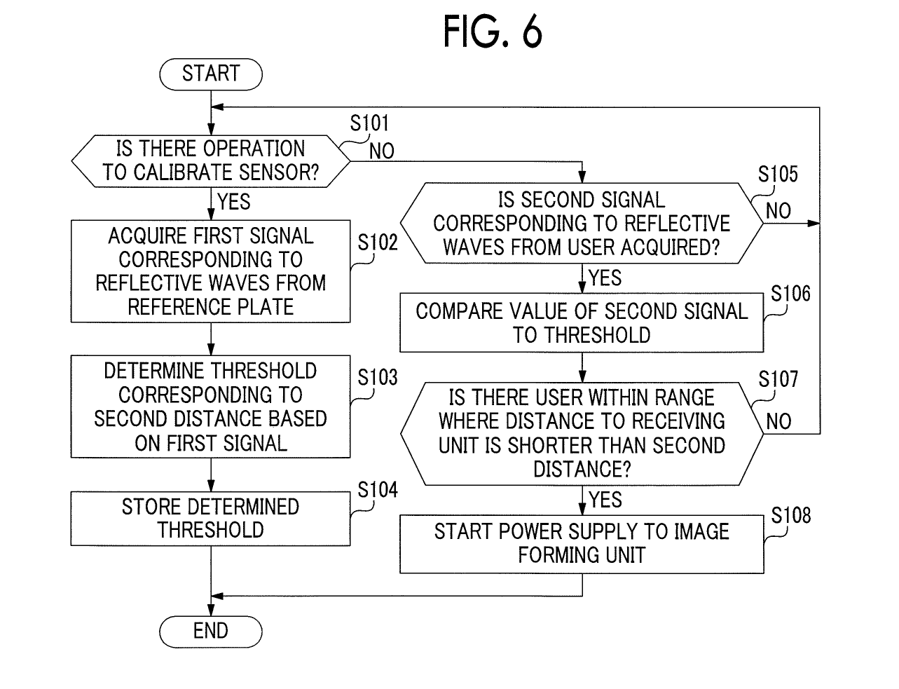

FIG. 6 is a flowchart showing an operation flow of the image forming apparatus 1 according to the first exemplary embodiment. The controller 11 of the image forming apparatus 1 determines whether or not there is an operation to calibrate the receiving unit 162 of the sensor 16 (Step S101). When it is determined that there is an operation (Step S101: YES), the controller 11 acquires the first signal corresponding to the reflective waves from the reference plate B, from the receiving unit 162 of the sensor 16 (Step S102). Thereafter, the controller 11 determines the threshold 121 corresponding to the second distance based on the acquired first signal (Step S103) and then stores the determined threshold 121 in the memory (Step S104).

On the other hand, when it is determined that there is no operation described above in Step S101 (Step S101: NO), the controller 11 determines whether or not the second signal corresponding to the reflective waves from the user as the object other than the reference plate B is acquired from the receiving unit 162 (Step S105). When it is determined that the second signal is not acquired (Step S105: NO), the controller 11 returns the process to Step S101. When it is determined that the second signal is acquired (Step S105: YES), the controller 11 compares the value represented in the acquired second signal with the threshold 121 stored in the memory 12 (Step S106), and determines whether or not the user is within the range where the distance to the receiving unit 162 is shorter than the second distance based on the comparison result (Step S107). When it is determined that there is no user within the range (Step S107: NO), the controller 11 returns the process to Step S101. On the other hand, when it is determined that the user is within the range (Step S107: YES), the controller 11 controls the power supply unit 18 so as to start the power supply to the image forming unit 13 (Step S108).

As described above, the receiving unit 162 of the sensor 16 is calibrated in such a manner that the reference plate B is disposed at the position separated from the determined first distance. Therefore, even in a case where a relatively large error occurs during producing with respect to the output of the receiving unit 162, in comparison with a case where the above-described calibration is not performed, the size of the range where the power supply is started when the user enters the range is determined with high accuracy.

### 2. Second Exemplary Embodiment

### 2-1. Overall Configuration of Image Forming Apparatus

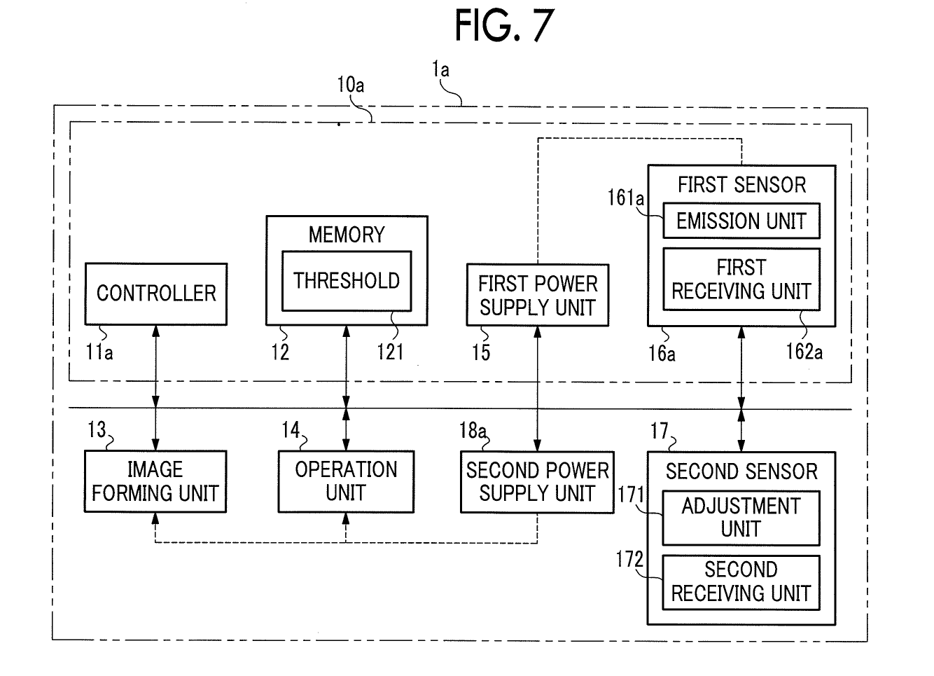

FIG. 7 is a block diagram showing an overall configuration of an image forming apparatus 1a according to a second exemplary embodiment of the invention. The image forming apparatus 1a is different from the image forming apparatus 1 according to the first exemplary embodiment in that the image forming apparatus 1a includes a first power supply unit 15 and a second sensor 17. A controller 11a corresponds to the controller 11 of the image forming apparatus 1 and realizes another function in addition to the function realized by the controller 11. A first sensor 16a corresponds to the sensor 16 of the image forming apparatus 1 and is different from the sensor 16 in that the first power supply unit 15 mostly supplies the electric power to the sensor 16a. A second power supply unit 18a corresponds to the power supply unit 18 of the image forming apparatus 1. The second distance is predetermined in the image forming apparatus 1 but the second distance in the image forming apparatus 1a changes in accordance with the operation of the user.

As shown in FIG. 7, the controller 11a, the memory 12, the first power supply unit 15 and the first sensor 16a function as a detecting device 10a that detects whether or not the object, such as the human body of the user, is within a range where a distance to a first receiving unit 162a of the first sensor 16a is shorter than the second distance.

As shown in FIG. 1, similarly to the first sensor 16a, the second sensor 17 is provided on the plate in the front side of the housing of the image forming apparatus 1. The second sensor 17 is provided with an adjustment unit 171 and a second receiving unit 172. The second receiving unit 172 of the second sensor 17 receives second detection waves emitted by the object that is present within a range R as shown in FIG. 1.

### 2-2. Configuration of Second Receiving Unit

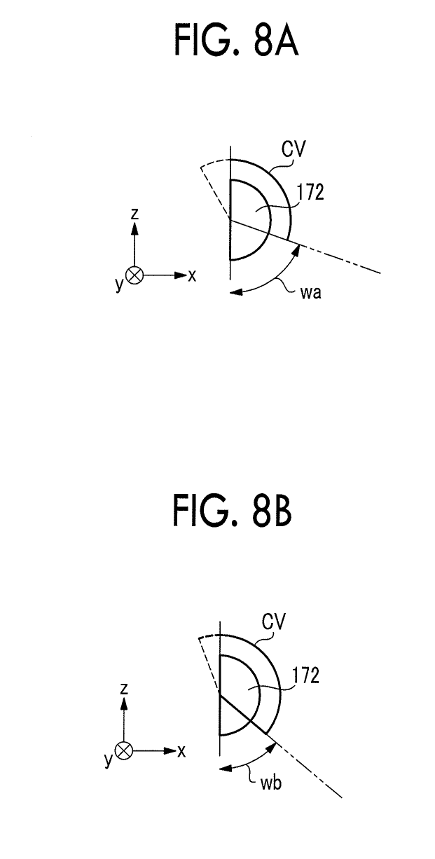

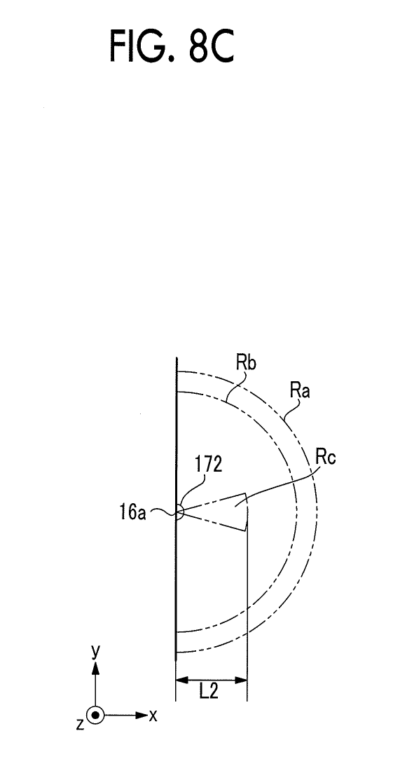

FIGS. 8A to 8C are views showing a configuration of the second receiving unit 172 according to the second exemplary embodiment. The second receiving unit 172 is provided on the plate in the front side of the housing of the image forming apparatus 1a. As shown in FIGS. 8A and 8B, the second receiving unit 172 hemispherically protrudes from the surface of the plate in the positive x-direction. The second receiving unit 172 receives the infrared rays from the environment thereof by using the hemispherical portion thereof.

A portion of the second receiving unit 172 is covered with a light blocking cover CV. The other portion of the second receiving unit 172 that is not covered with the light blocking cover CV is referred to as an “opening”.

The light blocking cover CV is supported by an axis passing through the center of the second receiving unit 172 to rotate around the axis. When the light blocking cover CV rotates about the axis, the size of the above-described opening is changed.

Since the human body of the user maintains a body temperature of approximately 37 degrees, the infrared rays (second detection wave) are emitted. The second receiving unit 172 receives the infrared rays passing through the above-described opening, among the infrared rays emitted from the human body of the user. According to this, when the second sensor 17 receives the infrared rays emitted from the user, the controller 11a detects that the user, (the human body of the user) as the object, is within a range determined in accordance with the size of the opening (hereinafter, referred to as second range). When the controller 11a detects that the user is within the second range, the controller 11a starts the power supply to the first sensor 16a by using the first power supply unit 15.

The adjustment unit 171 adjusts the size of the opening in accordance with the second distance set in response to the operation of the user. For example, the adjustment unit 171 is a solenoid (not shown in FIGS. 8A to 8C) that is expanded and contracted under the control of the controller 11a, or the like. The above-described light blocking cover CV is connected to the adjustment unit 171 that is the solenoid, and under the control of the controller 11a, the adjustment unit 171 is expanded and contracted so as to rotate the light blocking cover CV. The controller 11a adjusts the extent of expansion and contraction of the adjustment unit 171. According to this, the controller 11a adjusts the rotation angle of the light blocking cover CV, thereby adjusting the size of the opening.

For example, if the adjustment unit 171 causes the light blocking cover CV to take a posture as shown in FIG. 8A, the angle representing the size of the opening is wa. Therefore, the emission point of the infrared rays that pass through the opening and are received by the second receiving unit 172 is limited to the inside of a range Ra shown in FIG. 8C. The range Ra is the second range that is determined in accordance with the angle wa representing the size of the opening.

If the controller 11a controls the adjustment unit 171 so as to narrow the opening, the posture of the light blocking cover CV is, for example, a posture as shown in FIG. 8B. At this time, the angle representing the size of the opening is an angle wb which is sharper than the angle wa. Therefore, the emission point of the infrared rays that pass through the opening and are received by the second receiving unit 172 is limited to the inside of a range Rb which is narrower than the above-described range Ra. The range Rb is the second range that is determined in accordance with the angle wb representing the size of the opening.

The first sensor 16a includes an emission unit 161a that emits the infrared rays (first detection waves) different from the infrared rays emitted by the human body of the user. The emission unit 161a emits the infrared rays within a range of a region Rc shown in FIG. 8C. When the user enters the range where the distance to the first receiving unit 162a of the first sensor 16a is shorter than the distance L2, the emission unit 161a detects the presence of the user. The region Rc is included in the region Rb.

The detection is performed in the above-described manner. In other words, when the infrared rays emitted by the emission unit 161a are reflected to the human body (including clothes and accessories) of the user as the object, the first receiving unit 162a receives the reflective waves. Then, the first receiving unit 162a outputs the signal representing the value corresponding to the distance from the object that reflects the infrared rays. The controller 11a compares the value represented by the signal with the threshold that is determined so as to correspond to the distance L2 (second distance). The controller 11a detects whether or not the user, as the object, is within the range (hereinafter, referred to as first range) where the distance to the first receiving unit 162a is shorter than the distance L2, depending on the comparison result. When the controller 11a detects that the user is within the first range, the controller 11a controls the second power supply unit 18a so as to start the power supply to the image forming unit 13.

### 2-3. Functional Configuration of Image Forming Apparatus

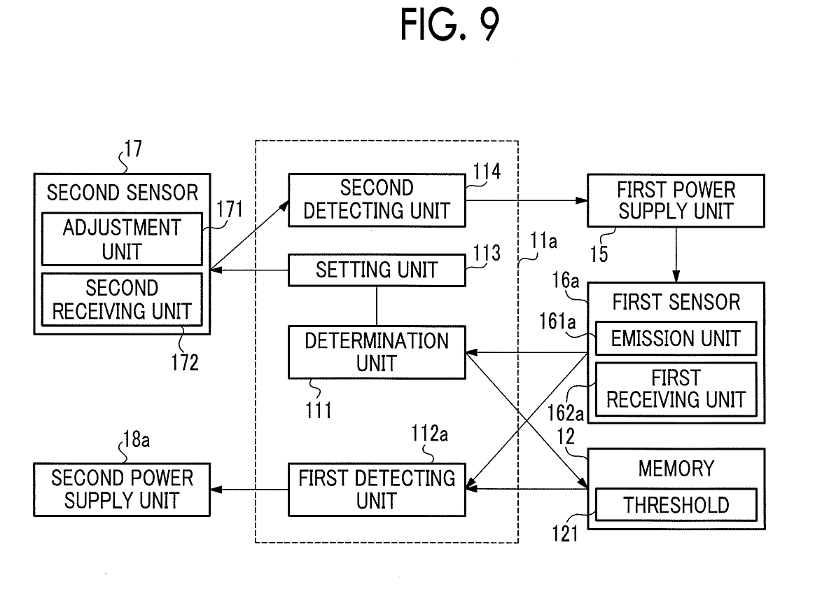

FIG. 9 is a diagram showing a functional configuration of the controller 11a of the image forming apparatus 1a according to the second exemplary embodiment. As shown in FIG. 9, the controller 11a functions as a determination unit 111, a first detecting unit 112a, a setting unit 113 and a second detecting unit 114.

The setting unit 113 sets the second distance depending on an instruction from the user. Specifically, the controller 11a acquires the instruction from the user corresponding to the operation of the operation unit 14 and interprets the instruction so as to realize the function of the setting unit 113. The operation in this case is performed in such a manner that the user pushes various operators (such as a so-called numerical keypad) for inputting numbers, for example, enters “3” → “5” → “0” → “Enter” in this order so as to set the second distance to be “350 mm”. The set second distance is stored in the RAM of the controller 11a so as to be transmitted to the determination unit 111. The set second distance may be stored in the memory 12. Moreover, the controller 11a controls the adjustment unit 171 of the second sensor 17, based on the set second distance, so as to adjust the size of the opening by the adjustment unit 171. When the size of the opening is adjusted, the second range, which is determined in accordance with the size of the opening, is determined. The second range is determined by the controller 11a and the adjustment unit 171 such that the second range includes the first range where the distance to the first receiving unit 162a is shorter than the second distance.

The determination unit 111 determines the threshold 121 corresponding to the second distance set by the setting unit 113, based on the value of the first signal that is output by the first receiving unit 162a when the infrared rays (first detection waves) emitted by the emission unit 161a reach the reference plate B and are reflected. The determined threshold 121 is stored in the memory 12.

The second detecting unit 114 detects that the human body of the user is within the second range determined in accordance with the size of the opening which is adjusted by the adjustment unit 171, in a case where the second receiving unit 172 receives the infrared rays (second detection waves) passing through the above-described opening among the infrared rays emitted from the human body of the user. Thereafter, when the second detecting unit 114 detects that the human body of the user is within the second range, the first power supply unit 15 supplies the electric power to the emission unit 161a or the first receiving unit 162a so as to drive the first detecting unit 112a.

The first detecting unit 112a compares the value of the second signal output by the first receiving unit 162a when the infrared rays (first detection waves) emitted by the emission unit 161a reach the human body of the user as an object other than the reference plate B and are reflected thereon, with the threshold 121 determined by the determination unit 111. Thereafter, the first detecting unit 112a detects whether or not the object is within the first range where the distance to the first receiving unit 162a is shorter than the second distance. When it is detected that the object is within the first range, the first detecting unit 112a controls the second power supply unit 18a so as to start the power supply to the image forming unit 13.

### 2-4. Operation of Image Forming Apparatus

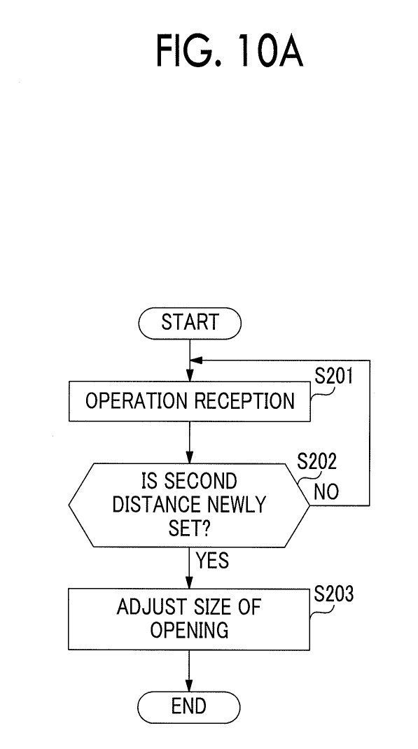

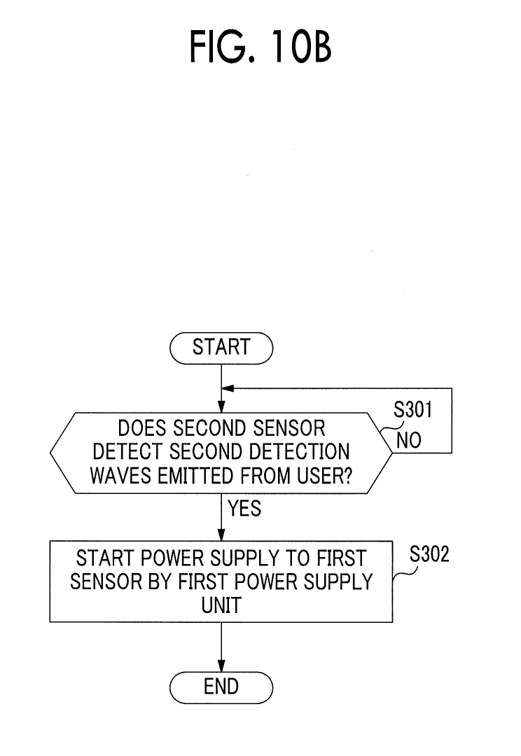

FIGS. 10A and 10B are flowcharts showing an operation flow of the image forming apparatus 1a according to the second exemplary embodiment. As shown in FIG. 10A, the controller 11a of the image forming apparatus 1a receives the operation from the user through the operation unit 14 (Step S201) and then determines whether or not the second distance is newly set depending on the received operation (Step S202). When it is determined that the new second distance has not been set (Step S202: NO), the controller 11a returns the process to Step S201.

On the other hand, when it is determined that the new second distance is set (Step S202: YES), the controller 11a controls the adjustment unit 171 so as to adjust the size of the opening (Step S203). According to this operation, whenever the second distance is newly set, the size of the opening is adjusted to the size corresponding to the set second distance. Therefore, the second range, which is determined in accordance with the size of the opening, is determined. The controller 11a adjusts the size of the opening such that the first range where the distance to the first receiving unit 162a is shorter than the second distance does not exceed the second range. According to this, the controller 11a changes the second range.

As shown in FIG. 10B, the controller 11a determines whether or not the second sensor 17 detects the infrared rays (second detection waves) emitted from the user (Step S301). When it is determined that the second sensor 17 does not detect the infrared rays emitted from the user (Step S301: NO), the controller 11a continues this determination operation. On the other hand, when it is determined that the second sensor 17 detects the infrared rays emitted from the user (Step S301: YES), the controller 11a determines that the user enters the above-described second range so as to start the power supply to the first sensor 16a by the first power supply unit 15 (Step S302).

According to this, even in a state where the electric power is not supplied to the first sensor 16a, when the user enters the second range, the power supply to the first sensor 16a is started. Therefore, the preparation for detecting whether or not the user is within the first range is completed prior to the user further approaching the image forming apparatus la to enter the first range.

### 3. Modified Example

The description of the exemplary embodiments has been made as described above, but the content of the exemplary embodiments may be modified as described below. Further, modified examples described below may be combined.

### 3-1. Modified Example 1

In the above-described exemplary embodiments, the detecting device 10 is integrally embedded into the image forming apparatus 1, but the detecting device 10 may be an individual device from the image forming apparatus 1. In this case, for example, the detecting device 10 is provided with a communication unit that communicates using a communication line, and the detecting device 10 may communicate with the image forming apparatus 1 that is provided with the power supply unit 18 and the image forming unit 13. When it is detected that an object such as the human body of a user is within the range where the distance to the receiving unit 162 is shorter than the predetermined distance, the detecting device 10 transmits a signal representing the detection result thereof to the image forming apparatus 1 using the above-described communication unit. When receiving the signal, the image forming apparatus 1 may supply the electric power to the image forming unit 13 by the power supply unit 18.

### 3-2. Modified Example 2

In the above-described second exemplary embodiment, the setting unit 113 receives the operation representing the instruction from the user through the operation unit 14. However, the image forming apparatus 1 may be separately provided with a terminal and may receive the operation representing the instruction from the user through the terminal. In this case, the terminal may be provided with a reception portion that receives the operation from the user at a position separated from the receiving unit 162. The terminal may be connected to the controller 11 of the image forming apparatus 1 through a wired line or a wireless line and transmit the signal corresponding to the operation received by the reception portion to the controller 11. When the reception portion receives the operation representing the instruction for setting the second distance, the signal corresponding to the operation is transmitted to the controller 11. Therefore, the above-described setting unit 113 sets the second distance depending on the instruction represented by the operation received by the reception portion.

When using the reception portion of the terminal, the user does not input specific numerical values using the operator such as the above-described numerical keypad but simply inputs only the instruction for setting. In this case, if the receiving unit 162 receives the reflective waves reflected from the human body of the user when the user inputs the instruction for setting, the controller 11 determines the threshold corresponding to the second distance, based on the value of the signal output by the receiving unit 162 at this time. That is to say, in this case, when the reception portion receives the operation, the setting unit 113 sets the distance from the user to the receiving unit 162 as the second distance.

After the starting of the power supply by the power supply unit 18, the setting unit 113 may receive the operation from the user for correcting the second distance, through the operation unit 14. For example, the controller 11 displays an inquiry about the starting time of the power supply to the user, on the display screen provided in the operation unit 14. Thereafter, the controller 11 may correct the second distance, based on an answer of the user in response to the inquiry. In this case, as to the inquiry about the start timing of the power supply, for example, the string of letters such as “Have you been waiting?” is displayed on the display screen. When the user selects the “YES” options with respect to this inquiry, the setting unit 113, the function of which is realized by the controller 11, may correct the second distance to make the second distance be shorter.

When two or more types of the second distances are determined in advance, the setting unit 113 may set the second distance which is used for determining the threshold 121, based on the instruction from the user for selecting the second distance among the two or more predetermined types of second distances.

### 3-3. Modified Example 3

In the above-described exemplary embodiments, the second distance is different from the first distance but may be concurrently used for the first distance. In this case, when the reference plate B is disposed on the path of the infrared rays emitted by the emission unit 161 and on the borderline in the range where it is determined whether or not the object is present, the determination unit 111 may determine the value of the signal output by the receiving unit 162 as the threshold 121. In this case, since the second distance is concurrently used for the first distance, the reference plate is disposed at the second distance so as to perform the calibration. Therefore, the sensor output [v] obtained during the calibration may be used for the threshold 121, without changing.

### 3-4. Modified Example 4

In the above-described second exemplary embodiment, when the second sensor 17 receives the infrared rays emitted from the user, the controller 11a starts the power supply to the first sensor 16a by the first power supply unit 15. However, the first sensor 16a may be supplied with the electric power in regardless of this condition. In this case, the first power supply unit 15 and the second sensor 17 may not be provided. In other words, the controller 11a may function as the setting unit 113 that sets the second distance depending on the instruction from the user.

### 3-5. Modified Example 5

In the above-described exemplary embodiments, when it is detected that the user is within the first range, the controller 11 (11a) controls the power supply unit 18 (second power supply unit 18a) so as to start the power supply to the image forming unit 13. However, the configuration in which the electric power is supplied and the process is executed may not be limited to the image forming unit 13. This configuration, for example, may be applied to an image reading unit that executes the process to read an image recorded in a medium as in the above-described process, or may be applied to a transmitting unit that transmits information stored in a memory to a designated terminal or the like. Moreover, this configuration may be applied to a computing unit that executes various scientific computations such as the strength calculation of structures and the molecular design of chemicals. In other words, when it is detected that the user is within the first range, the controller 11 may control the power supply unit 18 so as to start the power supply to a processing unit, thereby causing the processing unit to execute a process.

### 3-6. Modified Example 6

Each program executed by the controller 11 of the image forming apparatus 1 or the controller 11a of the image forming apparatus la may be provided in a state where each program is stored in a computer readable recording medium including a magnetic recording medium such as a magnetic tape and a magnetic disk; an optical recording medium such as an optical disc; a magneto-optical recording medium; a semiconductor memory, or the like. The program may be downloaded, for example, through a communication line such as the Internet. There is a case where the controller exemplified as in the above-described controller 11 (11a) maybe applied to various units in addition to the CPU in some cases. For example, an exclusive processor may be used.

### 3-7. Modified Example 7

In the above-described exemplary embodiments, any of three reference curves are applied to the characteristics of the receiving unit 162, but the applied reference curves are not limited to three, but may be two, or four or more. The characteristics of the receiving unit 162 may be obtained without applying a predetermined reference curve. The controller 11 may newly estimate a reference curve based on the value of the signal corresponding to the reflective waves output by the receiving unit 162 that receives the reflective waves from the reference plate B disposed at the distance L1. Thereafter, the controller 11 may determine the sensor output corresponding to the distance L2 on the estimated reference curve as the threshold 121. For example, if the reference curve is represented as a polynomial equation in which the detection distance is set as an independent variable so as to derive the sensor output, this estimation is performed in such a manner that the above-described distance L1 is combined with the value of the signal output by the receiving unit 162 and then each coefficient of the polynomial equation is specified.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A detecting device comprising:
an emission unit that emits first detection waves in order to detect presence of an object;
a first receiving unit that receives reflective waves of which the first detection waves emitted by the emission unit reach the object and are reflected thereon, and outputs a signal representing a value corresponding to a distance from the object based on the reflective waves;
a determination unit that determines a threshold corresponding to a predetermined second distance based on a value of a first signal output by the first receiving unit when the first detection waves reach a reference plate and are reflected thereon, in a case where the reference plate is disposed on a path of the first detection waves emitted by the emission unit and at a position where a distance to the first receiving unit is a predetermined first distance; and
a first detecting unit that compares a value of a second signal output by the first receiving unit when the first detection waves emitted by the emission unit reach the object other than the reference plate and are reflected thereon, with the threshold determined by the determination unit, and detects whether or not the object is within a first range where the distance to the first receiving unit is shorter than the second distance.

2. The detecting device according to claim 1, further comprising:
a setting unit that sets the second distance depending on an instruction from a user,
wherein the determination unit determines the threshold corresponding to the second distance set by the setting unit, based on the value of the first signal.

3. The detecting device according to claim 2, further comprising:
a reception portion that receives the operation from the user at a position separated from the first receiving unit,
wherein the setting unit sets the distance from the user to the first receiving unit as the second distance, when the reception portion receives the operation, and
wherein the first detecting unit detects whether or not the user, as the object, is within the first range.

4. The detecting device according to claim 2, further comprising:
a second receiving unit that is provided in a housing with an opening and receives second detection waves which are emitted from the object and pass through the opening;
an adjustment unit that adjusts the size of the opening in accordance with the second distance set by the setting unit;
a second detecting unit that detects whether or not the object is within a second range determined in accordance with the size of the opening which is adjusted by the adjustment unit, when the second receiving unit receives the second detection waves; and
a first power supply unit that supplies electric power to the emission unit or the first receiving unit so as to drive the first detecting unit, when the second detecting unit detects that the object is within the second range.

5. The detecting device according to claim 3, further comprising:
a second receiving unit that is provided within a housing having an opening and receives second detection waves which are emitted from the object and pass through the opening;
an adjustment unit that adjusts the size of the opening in accordance with the second distance set by the setting unit;
a second detecting unit that detects whether or not the object is within a second range determined in accordance with the size of the opening which is adjusted by the adjustment unit, when the second receiving unit receives the second detection waves; and
a first power supply unit that supplies electric power to the emission unit or the first receiving unit so as to drive the first detecting unit, when the second detecting unit detects that the object is within the second range.

6. A processing device comprising:
the detecting device according to claim 1;
a processing unit that executes a determined process, when the power supply is performed; and
a second power supply unit that supplies electric power to the processing unit so as to execute the process, when the first detecting unit of the detecting device detects that the object is within the first range.

7. An image forming apparatus comprising:
the detecting device according to claim 1;
an image forming unit that forms a determined image, when the power supply is performed; and
a second power supply unit that supplies electric power to the image forming unit so as to form the image, when the first detecting unit of the detecting device detects that the object is within the first range.

8. A non-transitory computer readable medium storing a program causing a computer, which controls a detecting device that includes an emission unit that emits first detection waves in order to detect presence of an object, and a first receiving unit that receives reflective waves of which the first detection waves emitted by the emission unit reach the object and are reflected thereon, and outputs a signal representing a value corresponding to a distance from the object based on the reflective waves, to function as:
a determination unit that determines a threshold corresponding to a predetermined second distance based on a value of a first signal output by the first receiving unit when the first detection waves reach a reference plate and are reflected thereon, in a case where the reference plate is disposed on a path of the first detection waves emitted by the emission unit and at a position where a distance to the first receiving unit is a predetermined first distance; and
a first detecting unit that compares a value of a second signal output by the first receiving unit when the first detection waves emitted by the emission unit reach the object other than the reference plate and are reflected thereon, with the threshold determined by the determination unit, and detects whether or not the object is within a first range where the distance to the first receiving unit is shorter than the second distance.
